(19) United States
(12) Patent Application Publication
(10) Pub. No.: US 2024/0202390 A1
(43) Pub. Date: Jun. 20, 2024

(54) METHOD AND SYSTEM FOR DEVELOPMENT AND TESTING VIA SIMULATION

(71) Applicant: dSPACE GmbH, Paderborn (DE)

(72) Inventors: Torsten Kluge, Paderborn (DE); Fabian Sauer, Paderborn (DE); Dennis Roeser, Paderborn (DE)

(21) Appl. No.: 18/173,814

(22) Filed: Feb. 24, 2023

(30) Foreign Application Priority Data
Dec. 15, 2022 (DE) 102022133518.6

(51) Int. Cl. G06F 30/20

(52) U.S. Cl. CPC G06F 30/20; G06F 2111/02

(57) ABSTRACT

Multi-component systems and/or interacting components thereof are developed and tested via simulation. The simulation includes at least two entities exchanging state data with one another. A method for such development and testing includes: an entity requesting to join a simulation; and the requesting entity joining the simulation in such a way that the transmission of state data by the requesting entity takes place substantially simultaneously with the transmission of state data by an entity that has previously joined the simulation.

### CROSS-REFERENCE TO PRIOR APPLICATIONS

Priority is claimed to German Patent Application No. DE 102022133518.6, filed on Dec. 15, 2022, the entire disclosure of which is hereby incorporated by reference herein.

### FIELD

The invention relates to a computer-implemented method and a system for the development and testing of multi-component systems and the interacting components thereof via simulation.

### BACKGROUND

Simulation methods and systems are used to develop and test multi-component systems, such as vehicles, aircraft, automation systems or road users in traffic scenarios and the interacting components thereof as well as control loops.

In this context, reference is often made to entities, which may include systems controlled by a human operator or automated systems that complement the simulation environment. At least two entities can work on a common simulation task. For this purpose, each of the at least two entities runs a local simulation of a virtual test system and regularly exchanges state data with the other entities.

Purely local simulations, in which entities are only run at one location, make it difficult for heterogeneous, organizationally and geographically distributed simulation participants to participate.

In simulations in which the at least two entities are arranged in a distributed manner and are connected via a communication infrastructure, for example via an Internet-like network infrastructure, maintaining real time is particularly problematic. When data are exchanged between the entities, the necessary control over the transmission path in order to minimize latency and jitter is missing. Entities dynamically joining a running simulation likewise poses a problem.

### SUMMARY

In an exemplary embodiment, the present invention provides a method for development and testing of multi-component systems and/or interacting components thereof via simulation. The simulation comprises at least two entities exchanging state data with one another. The method comprises: an entity requesting to join a simulation; and the requesting entity joining the simulation in such a way that the transmission of state data by the requesting entity takes place substantially simultaneously with the transmission of state data by an entity that has previously joined the simulation.

### BRIEF DESCRIPTION OF DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 depicts a simplified representation of a simulation method having at least two entities and a coordination entity;

FIG. 2a depicts a representation of the exchange of data between an entity and a coordination entity on a time axis;

FIG. 2b depicts a representation of the exchange of data between two entities and a coordination entity on a time axis;

FIGS. 3-4 depict representations of embodiments of a method according to the invention on a time axis;

FIGS. 5-6 depict simplified flow diagrams of embodiments of a method according to the invention;

FIG. 7 depicts a simplified block diagram of an embodiment of a system according to the invention; and

FIG. 8 depicts a simplified block diagram of an embodiment of a simulation device of a system according to the invention.

### DETAILED DESCRIPTION

Exemplary embodiments of the present invention provide an improved method and system for the development and testing of multi-component systems and the interacting components thereof via simulation. In particular, faster simulations are made possible by distributed running in real time on heterogeneous platforms and infrastructures, in particular heterogeneous simulation platforms, operating systems and/or network infrastructures, which entities simulating virtual simulation participants can join dynamically.

Simulation platforms can include, for example, platforms such as VEOS, SCALEXIO, and SUMO. Operating systems can include, for example, operating systems such as Windows, Linux, and RT-Linux.

Real time denotes an operation in which the processing results are available within a predetermined, in particular guaranteed, period of time, in particular in which data processing or communication of the processing results takes place simultaneously or almost simultaneously with parallel processes and/or operations.

In particular, this offers the advantage that simulation devices can be better provided, in particular as required and with reduced effort, and multi-component systems and the interacting components thereof can be tested and developed with reduced effort, greater reliability, and better quality.

According to a first aspect of the invention, a computer-implemented method for the development and testing of multi-component systems and/or the interacting components thereof via simulation is provided. The simulation comprises at least two entities exchanging state data with one another. In this case, the method comprises, as one step, an entity requesting to join a simulation and, as a further step, the requesting entity joining the simulation in such a way that the transmission of state data by the requesting entity takes place substantially simultaneously with the transmission of state data by an entity that has previously joined.

In particular, this helps to improve the process of entities dynamically joining a running simulation and to reduce the risk of real-time violations, for example due to latency differences, jitter, or complex local calculations.

Preferably, a requesting entity joins in such a way that the time at which the requesting entity transmits its state data, in particular for the first time after receiving permission to join, is delayed by a first delay interval. In particular, this makes it possible to reduce the effort involved in an entity dynamically joining a running simulation.

In a further embodiment of a method according to the invention, the requesting entity joins in such a way that the time at which the state data is transmitted to an entity that has already joined is delayed by a second delay interval.

Preferably, after receiving permission to join, the state data of an entity are transmitted for the first time at the beginning of a constant time interval predefined for the transmission of state data. Subsequent transmissions of state data preferably take place at time intervals which in each case correspond to or are derived from this constant time interval predefined for the transmission of state data.

In particular, this helps to further reduce the risk of real-time violations and to reduce the effort involved in the dynamic joining by an entity and in the performance of a simulation with at least two entities.

An entity preferably calculates one or more steps of the simulation locally between a first and a subsequent second transmission of state data. In this case, the local calculation can be performed via such state data and/or extrapolation of such state data of another entity that the entity has received as a result of the first transmission of state data. The local calculation can comprise a predefined number of steps. Likewise, the local calculation of a step can take place within a predefined, constant time interval and/or correspond to a predefined, constant time interval in the simulated test environment.

This makes it possible, in particular, to reduce the volume of the data exchange between entities of a running simulation and the effort involved in coordinating them. In addition, this results in a reduced risk of real-time violations and better provision of simulation devices.

An exchange of state data between at least two entities preferably comprises, as one step, a coordination entity receiving state data from at least two entities and, as a further step, the coordination entity transmitting the received state data as combined state data to the at least two entities. The combined state data can be transmitted at a time after the state data of the at least two entities have been received, processed, and/or supplemented by the coordination entity, in particular supplemented via state data from automated participants.

In this case, the combined state data transmitted to a respective entity can contain only or mostly state data which are necessary for the local performance of the simulation by the respective entity. This helps in particular to provide a virtual test environment that is better suited for the development and testing of systems and components and to reduce the amount of data having to be received and processed by a respective entity or simulation device via a network infrastructure. Furthermore, this helps to reduce the risk of a real-time violation and to better provide simulation devices.

Receiving permission to join the simulation preferably causes the requesting entity to transmit its state data, in particular for the first time after receiving permission to join.

This makes it possible, in particular, to reduce the volume of the data exchange between entities of a running simulation and the effort involved in coordinating them.

A transmission time at which the entity is to transmit state data, in particular for the first time after receiving permission to join, is preferably determined for an entity. The transmission time is determined in such a way that the transmission of state data takes place substantially simultaneously with the transmission of state data by another entity.

The transmission time can preferably be determined as a function of a predefined, constant time interval for transmitting state data and/or of a signal propagation time for transmitting state data. The signal propagation time can preferably be determined via measurement and/or calculation.

This makes it possible, in particular, to improve the process of entities dynamically joining a running simulation and/or the simultaneity of the transmission of data by the entities during a running simulation. In particular, this helps to better reduce the risk of real-time violations.

Preferably, at least one entity comprises or forms a component of a system to be developed or tested, in particular a vehicle, an aircraft, and/or an automation, which can be present, for example, as a model-in-the-loop (MIL), software-in-the-loop (SIL), and/or hardware-in-the-loop (HIL). In this case, the entity can preferably influence a behavior of a virtual model of the system via the component during the simulation.

Hardware-in-the-loop denotes a real component, for example a real electronic control unit or a real mechatronic component that is connected via its inputs and outputs to an adapted counterpart, in particular to a simulation device, so that the behavior of the component can be tested.

Software-in-the-loop denotes a component or a part of a component that does not exist as a hardware component but only as suitably configured software and can thus only be tested as software in a simulation device.

Model-in-the-loop denotes a component embedded in a model simulating its target environment or target system.

At least one entity is preferably run on a processing device, for example on a PC, a test bed, a server and/or in a cloud. Preferably, at least one entity can exchange a request to join a simulation, permission to join a simulation and/or state data with another entity via a heterogeneous, in particular Internet-type, network infrastructure.

This helps in particular to provide the most suitable simulation devices as required and with reduced effort. In particular, this makes it possible to test and develop multi-component systems and the interacting components thereof with reduced effort, greater reliability, and better quality.

According to a second aspect of the invention, a simulation system for the development and testing of multi-component systems and/or the interacting components thereof via simulation is provided.

The simulation comprises at least two entities exchanging state data with one another. The simulation system comprises at least two simulation devices which interact with one another and are configured to make requests by an entity to join a simulation and to allow the requesting entity to join the simulation in such a way that the transmission of state data by the requesting entity takes place substantially simultaneously with the transmission of state data by an entity that has previously joined.

In particular, this helps to improve the process of entities dynamically joining a running simulation and to reduce the risk of real-time violations, for example due to latency differences, jitter, or complex local calculations.

Preferably, the at least two simulation devices interacting with one another are further configured to allow the requesting entity to join the simulation in such a way that the time at which the requesting entity transmits its state data, in particular for the first time after receiving permission to join, is delayed by a first delay interval, and/or the time at which the state data of an entity that has previously joined are transmitted is delayed by a second delay interval.

In particular, this makes it possible to reduce the effort involved in an entity dynamically joining a running simulation. It also allows the most suitable combination of variants of the joining procedure to be selected for a respective running simulation, entity and/or simulation device.

Preferably, the at least two simulation devices interacting with one another are further configured to exchange state data between at least two entities in that a coordination entity receives state data from at least two entities and transmits the received state data as combined state data to the at least two entities at a time after the state data of the at least two entities have been received, processed, and/or supplemented by the coordination entity, in particular supplemented via state data from automated participants.

This helps in particular to provide a virtual test environment that is better suited for the development and testing of systems and components and to reduce the amount of data having to be received and processed by a respective entity or simulation device via a network infrastructure.

Preferably, the at least two simulation devices can in particular be PC-based, test bed-based, server-based, and/or cloud-based. Likewise, the at least two simulation devices can be communicatively connected via a heterogeneous, in particular Internet-like, network infrastructure. Preferably, the at least two simulation devices can be configured in such a way that they can carry out an embodiment of a method according to the invention according to the first aspect of the invention.

This helps in particular to better provide simulation devices, in particular as required and with reduced effort, and to develop and test multi-component systems and the interacting components thereof with reduced effort, greater reliability, and better quality.

According to a third aspect of the invention, a computer program product having instructions is provided which, when executed by one or more computers, causes the one or more computers to carry out an embodiment of a method according to the invention according to the first aspect of the invention and/or to implement an embodiment of a simulation device of a simulation system according to the second aspect of the invention.

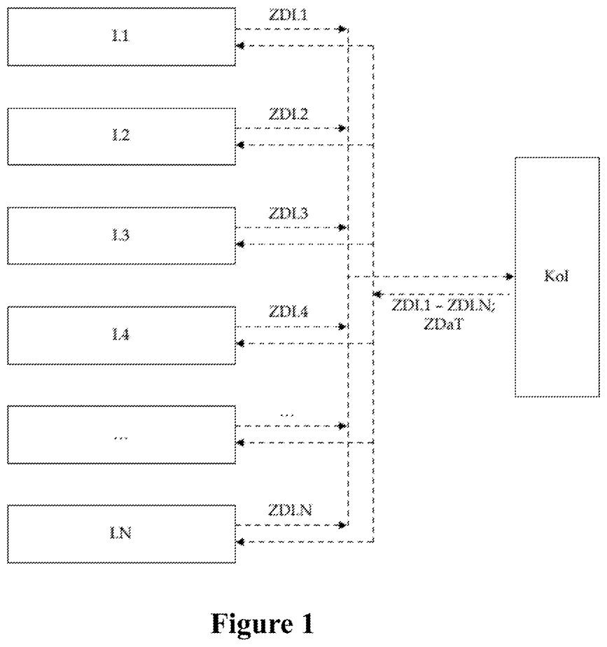

FIG. 1 shows an embodiment of a simulation method having at least two entities I.1-I.N and a coordination entity KoI. The method can run a traffic simulation with virtual test vehicles, for example.

The at least two entities I.1-I.N can each simulate at least one virtual test vehicle, which can be controlled and/or monitored by a human operator, for example. The coordination entity KoI combines and integrates the virtual test vehicles of the at least two entities I.1-I.N as road users into the traffic simulation. In addition, the coordination entity KoI can also add further, automated participants aT and their updated state data ZDaT, which can complete or supplement the test environment of the simulation.

Automated participants aT comprise entities of virtual systems participating in the simulation, which are automatically generated and/or the states of which are influenced in an automated manner, in particular by a coordination entity KoI. The number, the type and the permitted states of automated participants aT can be fixedly predefined and/or determined as a function of the type and/or the number of the at least two entities participating in a simulation.

In the case of a traffic simulation, automated participants aT can comprise further virtual vehicles, cyclists or pedestrians, for example, or simulation parameters, such as traffic lights, boom gates, road conditions or weather conditions.

During the running of the simulation, the at least two entities I.1-I.N and the coordinating entity KoI regularly exchange state data ZD with one another. To this end, the at least two entities I.1-I.N each transmit the current state data ZDI.1-ZDI.N of their respective virtual test vehicles to the coordination entity KoI. The coordination entity KoI updates the states of the virtual test vehicles in the traffic simulation, carries out further calculations if necessary and in turn transmits the thus updated state data ZDI.1-ZDI.N, if available, together with the updated state data ZDaT of the automated participants aT, to the at least two entities I.1-I.N.

Each of the at least two entities I.1-I.N can thus locally simulate a coherent virtual test environment that is coordinated with the states of the other entities I.1-IN; aT on the basis of current state data ZDI.1-ZDI.N; ZDaT. In this way, the other entities I.1-IN; aT appear as further participants in the local simulations of the at least two entities I.1-IN, in particular in an identical manner.

The state data of the at least two entities comprise the parameters and parameter values of a system simulated by an entity I.N or of an interacting component, which are required to perform a simulation. For example, in a traffic simulation, the state data ZDI.1-ZDI.N; ZDaT of a simulated virtual test vehicle can comprise, for example, position, speed, spatial orientation and/or acceleration.

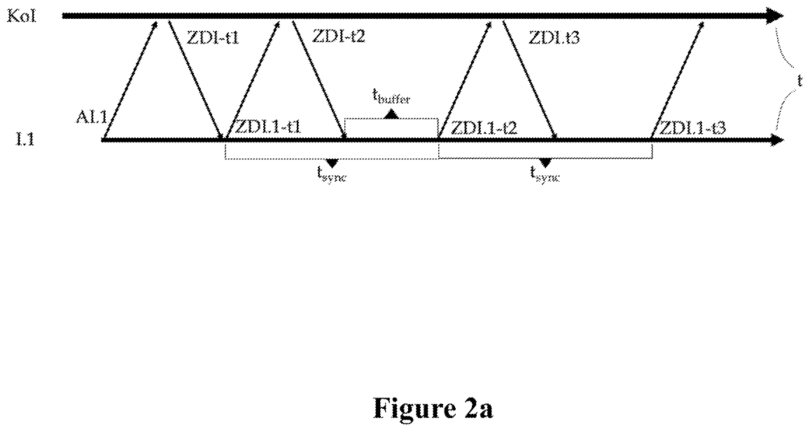

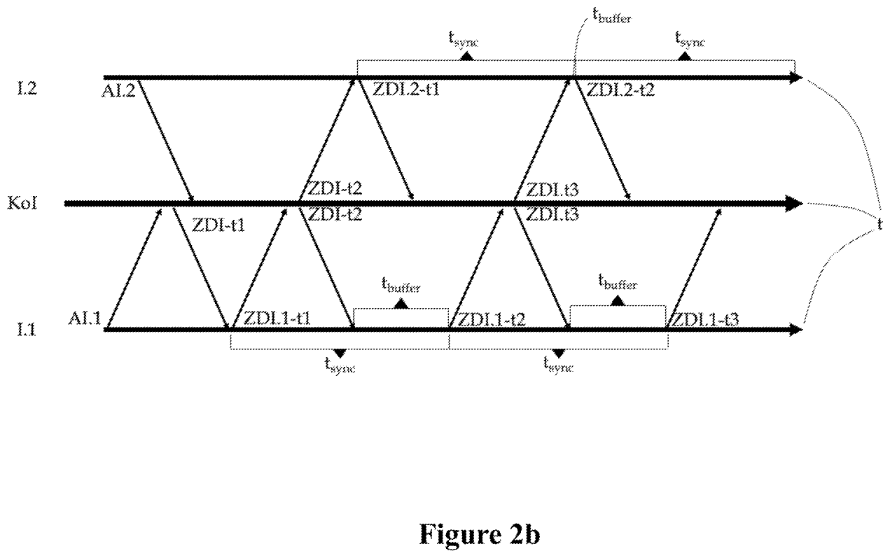

The diagram in FIG. 2a shows, by way of example, the exchange of data, in particular state data ZDI; ZDI.1 between an entity I.1 and a coordination entity KoI on a time axis t.

The entity I.1 transmits a request AI.1 to join a running simulation to the coordination entity KoI. The coordination entity KoI responds thereto with a first transmission of state data ZDI-t1 of the running simulation. The requesting entity I.1 interprets the first transmission ZDI-t1 as permission to join the simulation and responds in turn with a first transmission of its own state data ZI.1-t1 to the coordination entity KoI after receiving permission to join.

From this time, i.e., from the time of the first transmission of its own state data ZI.1-t1 after receiving permission to join the simulation, the requesting entity I.1 can transmit its own state data ZI.1 periodically. The period length can in this case correspond to a predefined macro time step interval t_{sync} of the simulation. The coordination entity KoI, on the other hand, waits to transmit back the updated state data ZDI-t2, ZDI-t3 until the state data ZDI.1-ZDI.N of all entities I.1-I.N that have already joined have been transmitted, since the coordination entity KoI can only then calculate a completely updated state ZDI.1-ZDI.N of the simulation or transmit it back to the at least two entities I.1-I.N.

Between two periodic transmissions of state data ZDI.N-tn; ZDI.N-tn+1 by an entity IN, i.e., within a macro time step interval t_{sync}, the simulation can be run locally by a joined entity I.N with a predefined number z of micro time steps. The entity I.N extrapolates the state data ZDI.1-ZDI.N-1; ZDaT (ZDaT not shown in FIG. 2a) of other entities I.1-IN-1; aT last received from the coordination entity KoI. In the traffic simulation example, each of the at least two entities I.1-I.N calculates, for example, the current position of other road users I.1-IN; aT based on their last received positions and speeds, or also accelerations, depending on the level of accuracy required.

Each micro time step can correspond to a predefined duration in the simulated test environment, for example in each case one millisecond ms. A predefined macro time step interval t_{sync} can be, for example, one to two orders of magnitude greater than the duration corresponding to a micro time step. In the specific example of a duration of 1 ms corresponding to a micro time step, a macro time step interval t_{sync} can be 100 ms, for example.

In the example in FIG. 2b, a second entity I.2 also transmits a request AI.2 to join the running simulation to the coordination entity KoI. The request is transmitted to the coordination entity KoI at a time after the coordination entity KoI has transmitted state data ZDI-t1 to the first entity I.1 for the first time, and the start time t1 and the subsequent times tn+1=t1+n*t_{sync} for the transmission of its state data ZDI.1-tn+1 are thus fixed.

After the first requesting entity I.1 that has already joined has transmitted its state data ZDI.1, the coordination entity KoI, if necessary after a short delay to update or recalculate the global simulation state, transmits the updated state data ZDI-t2 to the entity I.1 that has previously joined the simulation. The second requesting entity I.2 is in turn prompted by receiving these state data ZDI-t2 to transmit its own state data ZDI.2-t1 to the coordination entity KoI and subsequently periodically according to the macro time step interval t_{sync}. The result of this is that the transmission times of the second requesting entity I.2 are not coordinated with the transmission times of the entity I.1 that has already joined.

In contrast to the first requesting entity I.1, the second requesting entity I.2 subsequently has only a small part t_{buffer} of the macro time step interval t_{sync} available in each macro time step interval t_{sync} to take into account the state data ZDI.1 transmitted by the coordination entity KoI in the locally performed calculation of the simulation in micro time steps before it transmits its subsequent state data ZDI.2-t2 to the coordination entity KoI.

As a result, even a small delay compared to the macro time step interval t_{sync} can result in the state data ZDI.1 transmitted by the coordination entity KoI arriving at the second requesting entity I.2 so late that the full number z of micro time steps can no longer be performed locally. This can in particular result in the second requesting entity I.2 transmitting obsolete, faulty, or no state data at all in a subsequent transmission of the state data ZDI.2-t2.

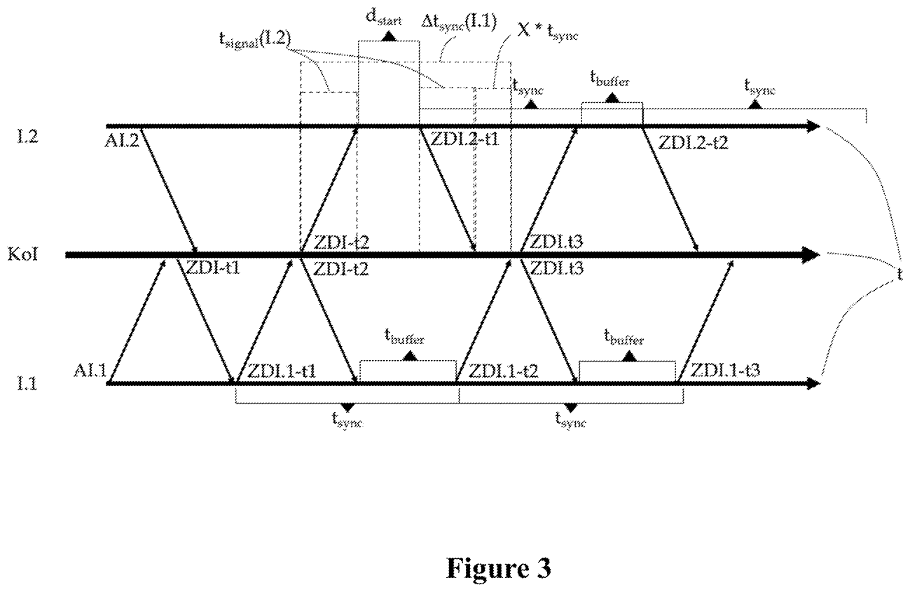

FIG. 3 shows an embodiment of a method according to the invention on a time axis, which solves the above problem and thereby in particular reduces the sensitivity of the system to latency differences, i.e., differences regarding the signal propagation times t_{signal} between the entities I.1-I.N, KoI, and jitter, i.e., unforeseen fluctuations in signal propagation times t_{signal}.

In the embodiment shown in FIG. 3, the coordination entity KoI transmits a delay time dₛₜₐᵣₜ for the transmission of the state data ZDI.2-t1 by the second requesting entity I.2 to the second requesting entity I.2 in addition to state data ZDI.1-t2. This delay time dₛₜₐᵣₜ is selected such that the state data ZDI.2-t1 of the second requesting entity I.2 are received by the coordination entity KoI approximately simultaneously with the state data ZDI.1-t2 of the first requesting entity I.1 that has already joined.

The delay time dₛₜₐᵣₜ can be determined, for example, substantially according to the following calculation term:

dₛₜₐᵣₜ(I.2)=Δt_{sync}(I.1)−2*t_{signal}(I.2)−X*t_{sync};

where
dₛₜₐᵣₜ(I.2) denotes the delay time which is to be allocated and transmitted to the second requesting entity I.2 by the coordination entity KoI;
Δt_{sync}(I.1) denotes the remaining duration of the current macro time step interval t_{sync} up to the time at which the entity I.1 that has already joined subsequently transmits its state data ZDI.1-t2 to the coordination entity KoI;
t_{signal}(I.2) denotes the signal propagation time for transmitting data between the second requesting entity I.2 and the coordination entity KoI; and
X can assume a value between 0 and 1, for example a value less than 0.5 or less than 0.1, and X*t_{sync} denotes the duration of the sub-interval of the predefined macro time step interval t_{sync} within which the state data ZDI.1, ZDI.2 of the entities I.1, I.2 are to be transmitted to the coordination entity KoI, in particular in order to be deemed to have been transmitted substantially simultaneously and/or at the beginning of the macro time step interval t_{sync}.

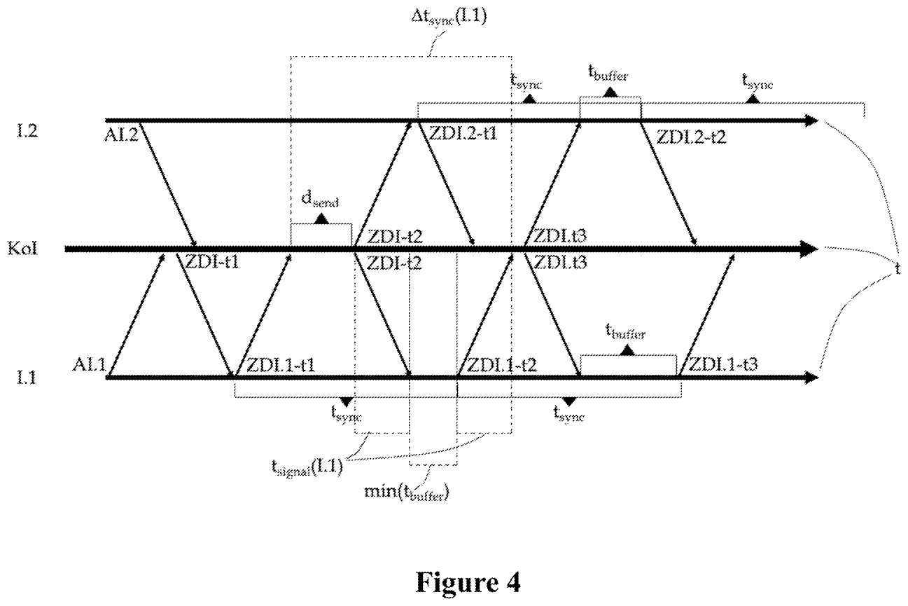

FIG. 4 shows a further embodiment of a method according to the invention.

In contrast to the embodiment of the invention presented above, the coordination entity KoI does not determine and transmit a delay time dₛₜₐᵣₜ for the second requesting entity I.2 but rather delays the transmission of the state data ZDI.1-t2 of the entities I.1 that have already joined to the second requesting entity I.2, just as it does to the entities I.1 that have already joined, by a delay time d_{send}. The delay time d_{send} is determined in such a way that, through a corresponding delay in the transmission of the state data ZDI.1-t2 by the coordination entity KoI, the transmission of the state data ZDI.2-t1 of the second requesting entity I.2 and the transmission of the state data ZDI.1-t2 of the entity I.1 that has already joined take place approximately simultaneously, in particular within a predefined interval X*t_{sync} at the beginning of a predefined macro time step interval t_{sync}.

For example, the delay time d_{send} can be determined substantially according to the following calculation term, disregarding the signal propagation time t_{signal}(I.2) for the sake of simplicity:

d_{send}(I.2)=Δt_{sync}(I.1)−t_{signal}(I.1)−min(t_{buffer});

where
d_{send}(I.2) denotes the delay time with which the coordination entity KoI delays the time of transmission of the state data ZDI.1-t2 to all entities I.1, I.2;
t_{signal}(I.1) denotes the signal propagation time for transmitting data between the entity I.1 that has already joined and the coordination entity KoI; and
min(t_{buffer}) denotes a predefined lower buffer interval limit to reduce the risk of a real-time violation by the entity I.1 that has already joined.

The illustrated embodiments of a method according to the invention can be repeated accordingly for each entity I.N which, after a first entity I.1 has joined, transmits a request to join the simulation to the coordination entity KoI. As a result, in particular the times of transmission of the state data ZDI.1-ZDI.N of all entities I.1-I.N that have joined the simulation are coordinated with one another so that, for all entities I.1-IN, KoI, an almost complete macro time step interval t_{sync} is always available for updating the state data ZDI.1-ZDI.N, ZDaT, running the predefined number z of local micro time steps and exchanging the state data ZDI.1-ZDI.N; ZDaT. This increases the time buffer t_{buffer} for compensating for delays, for example due to complex calculations, extended or fluctuating signal propagation times t_{signal}, and thus reduces the risk of a timeout that violates real time.

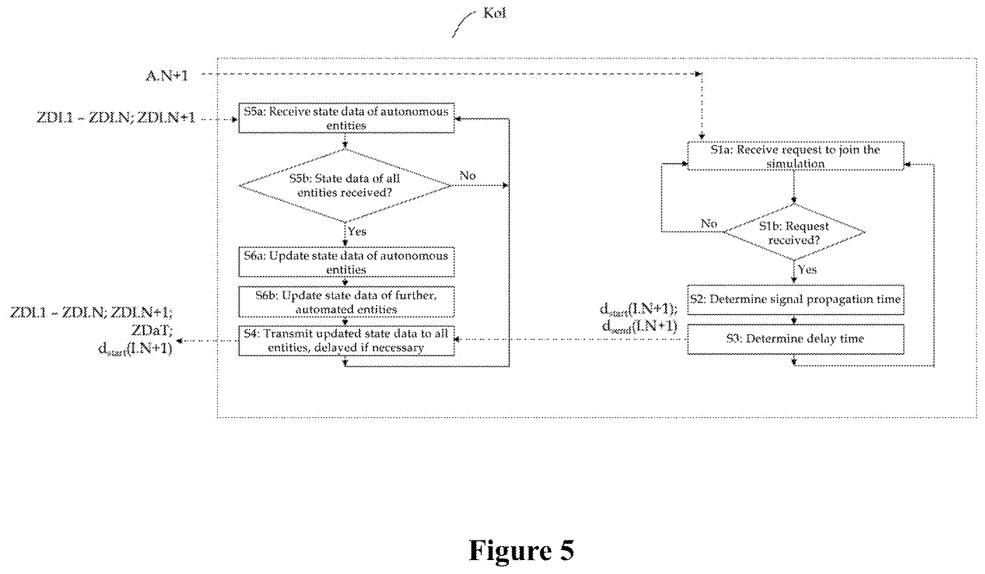

FIG. 5 shows a simplified flow diagram of an embodiment of a method according to the invention.

In a first step S1a, S1b, a coordination entity KoI detects a request A.N+1 from an entity I.N+1 to join a running simulation with entities I.1-I.N that have already joined. In a second step S2, the coordination entity KoI determines the signal propagation time t_{signal}(I.N+1) between the requesting entity I.N+1 and the coordination entity KoI. This can be done, for example, via time information contained in the request A.N+1 or by a separate propagation time measurement. In the subsequent step S3, the coordination entity KoI determines a delay time dₛₜₐᵣₜ(I.N+1); d_{send}(I.N+1) with which the requesting entity I.N+1 should delay the first transmission of its state data ZDI.N+1 after first receiving the state data ZDI.1-ZDI.N; ZDaT and/or the coordination entity KoI should delay transmission of the state data ZDI.1-ZDI.N; ZDaT to the requesting entity I.N+1 and the entities I.1-I.N that have already joined.

In a subsequent step S4, the coordination entity KoI causes the transmission of state data ZDI, which is delayed according to the invention, according to the delay time dₛₜₐᵣₜ(I.N+1); d_{send}(I.N+1) determined in the previous step S3. For this purpose, the coordination entity KoI can transmit the delay time dₛₜₐᵣₜ(I.N+1) determined in the previous step S3 to the requesting entity I.N+1, in particular simultaneously with the transmission of the state data ZDI.1-ZDI.N; ZDaT, by which the requesting entity I.N+1 is to delay the subsequent transmission of its state data ZDI.N+1. Likewise, the coordination entity KoI can delay the transmission of the combined state data ZDI.1-ZDI.N; ZDaT to the requesting entity I.N+1 and the entities I.1-I.N that have already joined, by the delay time d_{send}(I.N+1) determined in the previous step S3.

The delay times dₛₜₐᵣₜ(I.N+1); d_{send}(I.N+1) determined by the coordination entity KoI in the previous step S3 can assume the value zero and, in particular, can be excluded from the transmission in this case.

Likewise, data that is not required for a given entity I, in particular state data ZDI.1-ZDI.N; ZDaT, can be excluded from the transmission to this given entity I. For example, for a given entity, the data that can have no influence on the virtual text systems locally simulated by the entity I during a given macro time step interval t_{sync} are not necessary during the given macro time step interval t_{sync}. For example, this comprises state data ZDI from those participants that cannot be perceived by the locally simulated virtual test systems. In the example of the traffic simulation, this can comprise, for example, users who are located outside the range of simulated sensors of the virtual test vehicles.

In one step S5a, S5b following the transmission of the state data ZDI.1-ZDI.N; ZDaT, the coordination entity KoI receives the state data ZDI.1-ZDI.N+1 of all entities I.1-I.N+1 that have now joined.

As soon as all entities I.1-I.N+1 that have now joined have transmitted their state data ZDI.1-ZDI.N+1, the coordination entity KoI updates and combines the state data ZDI.1-ZDI.N+1; ZDaT of the simulation in a subsequent step S6a, S6b.

In one embodiment, the signal propagation times t_{signal}(I.1-t_{signal}(I.N+1) between the entities I.1-I.N+1 that have now joined and the coordination entity KoI can be determined in a manner comparable to the steps S2, S3 described above. In one embodiment, the signal propagation times t_{signal}(I.1)-t_{signal}(I.N+1) determined in this way can again be used to determine and transmit delay times dₛₜₐᵣₜ(I.1)-dₛₜₐᵣₜ(I.N+1) for the subsequent transmission of the state data ZDI.1-ZDI.N+1 by the entities I.1-I.N+1 that have now joined. In this way, it is possible to compensate for later changes in the signal propagation times t_{signal}(I.1)-t_{signal}(I.N+1), so that the state data ZDI.1-ZDI.N+1 of the entities I.1-I.N that have already joined can be better transmitted to the coordination entity KoI.

In the subsequent step S4, the coordination entity KoI again transmits the necessary, updated state data ZDI.1-ZDI.N+1; ZDaT to the entities I.1-I.N+1 that have joined. If necessary, as described above, this can again take place delayed by a delay time d_{send} or together with a delay time dₛₜₐᵣₜ determined for an entity I.

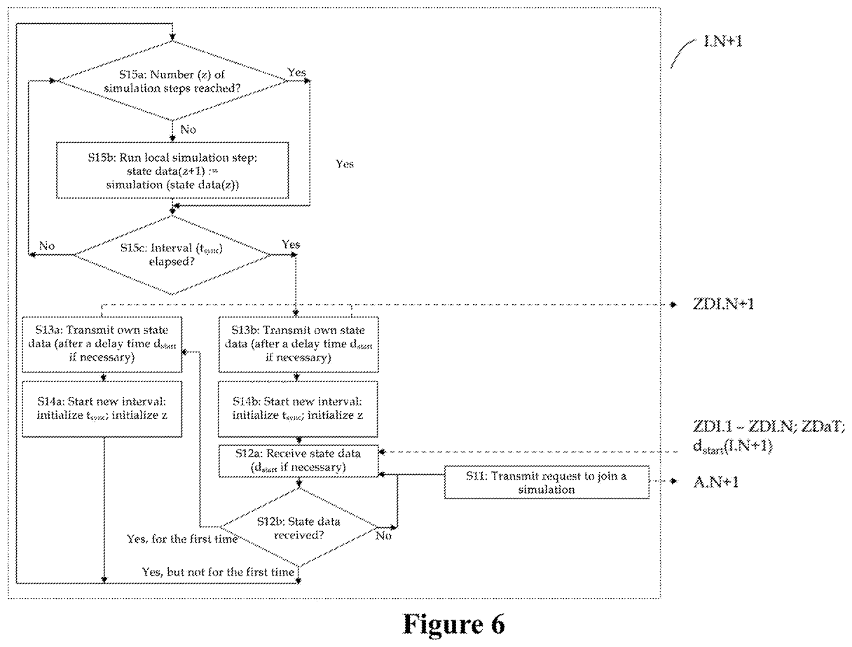

FIG. 6 shows a simplified flow diagram of an embodiment of a method according to the invention for the local running of an entity I.

An entity I.N+1 that wants to join a running simulation transmits a request A.N+1 to a coordination entity KoI in a first step S11. This request A.N+1 can already contain the state data ZDI.N+1 of the entity I.N+1 and/or time information for determining the signal propagation time t_{signal}(I.N+1) between the requesting entity I.N+1 and the coordination entity KoI.

In a second step S12a, S12b, the requesting entity I.N+1 receives the state data ZDI.1-ZDI.N; ZDaT of the running simulation and/or a delay time dₛₜₐᵣₜ(I.N+1) for the transmission of its own state data ZDI.N+1 for the first time. The entity I.N+1 interprets this as permission to join the simulation.

In a subsequent step S13a, the requesting entity I.N+1 transmits its own state data ZDI.N+1 to the coordination entity KoI. If no delay time dₛₜₐᵣₜ(I.N+1) was transmitted by the coordination entity KoI or the transmitted delay time dₛₜₐᵣₜ(I.N+1) has the value zero, the transmission of the requesting entity's own state data ZDI.N+1 to the coordination entity KoI takes place immediately after receiving permission to join. If a delay time dₛₜₐᵣₜ(I.N+1) greater than zero was transmitted, the transmission of the requesting entity's own state data ZDI.N+1 to the coordination entity KoI takes place at a correspondingly delayed time.

In a subsequent or parallel step S14a, the entity I.N+1 starts/initializes the macro time step interval t_{sync} for locally performing a predefined number of micro time steps z.

In a subsequent step S15b, the entity I.N+1 that has now joined performs the simulation locally in micro time steps until S15a the predefined number z of micro time steps has been performed or S15c the macro time step interval t_{sync} has elapsed. If the macro time step interval t_{sync} has elapsed before the predefined number z of micro time steps has been performed, the local performance of the simulation in one embodiment of a method according to the invention can be terminated before all z micro time steps are performed.

After the macro time step interval t_{sync}, including any delay time dₛₜₐᵣₜ that may have been transmitted, has elapsed in one embodiment, the entity I.N+1 again transmits its own state data ZDI.N+1 to the coordination entity KoI in a subsequent step S13b. In a subsequent or parallel step S14b, the entity I.N+1 initializes the macro time step interval t_{sync} for locally performing a predefined number z of simulation steps. In a subsequent step S12a, S12b, the entity I.N+1 again receives the state data ZDI.1-ZDI.N; ZDaT required for the entity I.N+1 and any delay time dₛₜₐᵣₜ(I.N+1) from the coordination entity KoI.

In the subsequent step S15b, the entity I.N+1 again locally performs the simulation in micro time steps. As already described above, the simulation is locally performed again until S15a the predefined number z of micro time steps has been performed or S15c the macro time step interval t_{sync}, including any delay time dₛₜₐᵣₜ(I.N+1) that may have been transmitted by the coordination entity KoI, has elapsed.

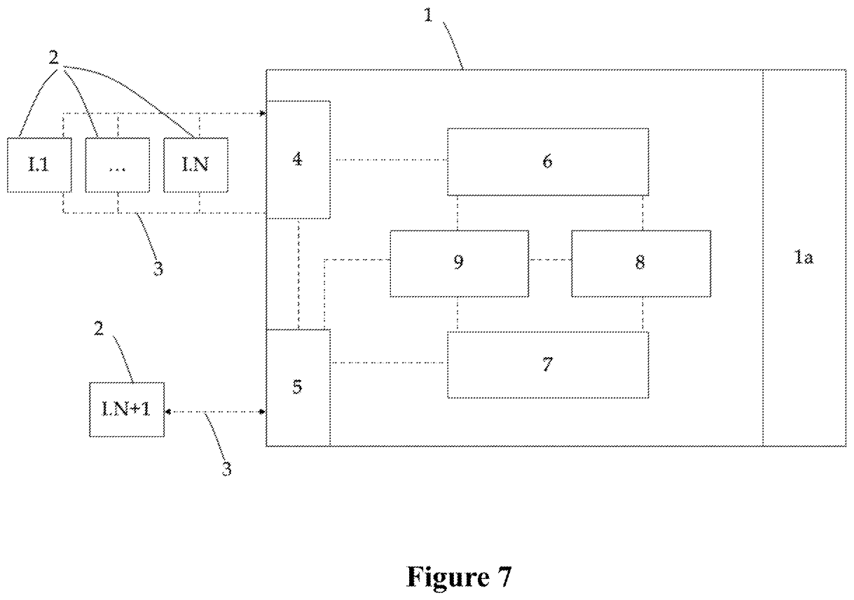

FIG. 7 shows, in a simplified block diagram, an embodiment of a system according to the second aspect of the invention.

The system comprises a first simulation device 1, which can comprise, for example, a server 1a and is configured to run a coordination entity KoI.

For this purpose, the first simulation device 1 comprises a first interface 4, which is configured for the data exchange with entities I.1-I.N that have already joined the simulation or that have transmitted a request to join. The first simulation device 1 also comprises a second interface 5, which is configured to receive a request A.N+1 from an entity I.N+1 to join a simulation.

Furthermore, the first simulation device 1 can comprise a pre-processing device 6, a post-processing device 7, further processing devices 8 and a cache 9. The pre-processing device 6 can in particular be configured to process state data ZDI.1-ZDI.N received from entities I.1-I.N directly and/or to store them in the cache 9, which is suitably configured for this purpose. The further processing devices 8 and the post-processing device 7 can be configured to perform further processing steps on the state data ZDI.1-ZDI.N; ZDaT, for example updating the state data ZDaT of automatic participants aT, adding joining entities I.N+1 and/or determining signal propagation times t_{signal} and/or delay times dₛₜₐᵣₜ; d_{send}.

The system furthermore comprises further simulation devices 2, which can comprise, for example, a PC or a test bed and are configured to run further entities I.1-I.N+1. These further simulation devices 2 are communicatively connected to the first simulation device 1 via a network infrastructure 3.

The further simulation devices 2 can be configured in particular to transmit requests A to join a simulation, to receive state data ZDI; ZDaT and/or delay times dₛₜₐᵣₜ, to simulate a virtual test system, to perform a simulation locally with a predefined number z of micro time steps, and/or to transmit their own state data ZDI periodically.

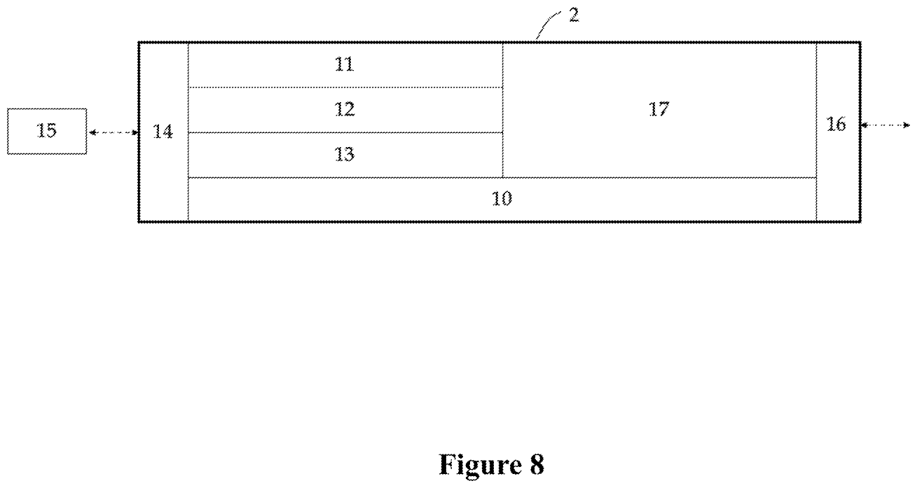

FIG. 8 shows, in a simplified block diagram, an embodiment of a further simulation device 2 according to the second aspect of the invention.

The simulation device 2 comprises, for example, a PC or a test bed 10. The simulation device 2 is configured to simulate a virtual multi-component system 11, such as a vehicle, a component 12 interacting therewith, and/or a control loop 13 of a component 12.

The system 11, the component 12 and/or the control loop 13 can be present, for example, as a MIL, SIL or HIL. Furthermore, the further simulation device 2 comprises a human-machine interface 14 which is configured so that a human operator 15 can influence and/or monitor the state of a simulated, virtual, multi-component system 11, an interacting component 12, and/or a control loop 13. The simulation device 2 also comprises an interface 16 for exchanging data ZDI, ZDaT; dₛₜₐᵣₜ with other entities I, KoI participating in a simulation and is configured to locally run a simulation model 17 comprising further participating entities I; aT, in particular by interpolating received state data ZDI; ZDaT.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for development and testing of multi-component systems and/or interacting components thereof via simulation, wherein the simulation comprises at least two entities exchanging state data with one another, and wherein the method comprises:
an entity requesting to join a simulation; and
the requesting entity joining the simulation in such a way that the transmission of state data by the requesting entity takes place substantially simultaneously with the transmission of state data by an entity that has previously joined the simulation.

2. The method according to claim 1, wherein the requesting entity joins the simulation in such a way that the time at which the requesting entity transmits its state data for the first time after receiving permission to join is delayed by a first delay interval.

3. The method according to claim 1, wherein the requesting entity joins the simulation in such a way that the time at which the state data are transmitted to an entity that has already joined the simulation is delayed by a second delay interval.

4. The method according to claim 1, wherein the first transmission of the state data of an entity after receiving permission to join takes place at the beginning of a predefined, constant time interval for the transmission of state data.

5. The method according to claim 4, wherein subsequent transmissions of the state data take place at time intervals which respectively correspond to this predefined, constant time interval for the transmission of state data.

6. The method according to claim 1, wherein an entity calculates one or more steps of the simulation locally between a first and a subsequent second transmission of state data; and
wherein:
the entity performs the local calculation via such state data and/or extrapolation of such state data of another entity that the entity has received as a result of the first transmission of state data, and/or
the local calculation comprises a predefined number of steps, and the local calculation of a step takes place within a predefined, constant time interval and/or corresponds to a predefined, constant time interval in the simulated test environment.

7. The method according to claim 1, wherein an exchange of state data between at least two entities comprises:
a coordination entity receiving the state data from at least two entities; and
the coordination entity transmitting the received state data as combined state data to the at least two entities;
wherein the combined state data are transmitted at a time after the state data of the at least two entities have been received, processed, and/or supplemented by the coordination entity; and
wherein the combined state data transmitted to a respective entity at least contains such state data that are necessary for the local performance of the simulation by the respective entity.

8. The method according to claim 1, wherein receiving permission to join the simulation causes the requesting entity to transmit its state data for the first time after receiving permission to join.

9. The method according to claim 1, wherein a transmission time is determined for an entity, at which time the entity is to transmit state data for the first time after receiving permission to join the simulation, and the transmission time is determined in such a way that the transmission of the state data takes place substantially simultaneously with the transmission of the state data by another entity.

10. The method according to claim 9, wherein the transmission time is determined as a function of a predefined, constant time interval for transmitting state data and/or of a signal propagation time for transmitting state data.

11. The method according to claim 1, wherein at least one entity comprises a component of a vehicle, an aircraft, and/or an automation present as a model-in-the-loop (MIL), software-in-the-loop (SIL), and/or hardware-in-the-loop (HIL), and the entity influences a behavior of a virtual model of the vehicle, the aircraft, and/or the automation via the component during the simulation.

12. The method according to claim 1, wherein an entity is run on a personal computer (PC), a test bed, a server, and/or in a cloud, and/or exchanges a request to join a simulation, permission to join a simulation, and/or state data with another entity via a heterogeneous, Internet-like network infrastructure.

13. A simulation system for development and testing of multi-component systems and/or interacting components thereof via simulation, wherein the simulation comprises at least two entities exchanging state data with one another, and the simulation system comprises:
at least two simulation devices interacting with one another;
wherein the at least two simulation devices are configured to:
make requests by an entity to join the simulation; and
allow the requesting entity to join the simulation in such a way that the transmission of state data by the requesting entity takes place substantially simultaneously with the transmission of state data by an entity that has previously joined the simulation.

14. The simulation system according to claim 13, wherein the at least two simulation devices interacting with one another are further configured to allow the requesting entity to join the simulation in such a way that the time at which the requesting entity transmits its state data for the first time after receiving permission to join the simulation is delayed by a first delay interval, and/or the time at which the state data are transmitted to an entity that has already joined the simulation is delayed by a second delay interval.

15. The simulation system according to claim 13, wherein the at least two simulation devices interacting with one another are further configured to exchange state data between at least two entities such that a coordination entity receives state data from at least two entities and transmits the received state data as combined state data to the at least two entities at a time after the state data of the at least two entities have been received, processed, and/or supplemented by the coordination entity.

16. The simulation system according to claim 13, wherein the at least two simulation devices are personal computer (PC)-based, test bed-based, server-based, and/or cloud-based, and are communicatively connected via a heterogeneous, Internet-like network infrastructure.

17. One or more non-transitory computer-readable mediums having processor-executable instructions stored thereon for development and testing of multi-component systems and/or interacting components thereof via simulation, wherein the simulation comprises at least two entities exchanging state data with one another, and wherein the processor-executable instructions, when executed, facilitate:
an entity requesting to join a simulation; and
the requesting entity joining the simulation in such a way that the transmission of state data by the requesting entity takes place substantially simultaneously with the transmission of state data by an entity that has previously joined the simulation.
